(19) United States
(12) Patent Application Publication
(10) Pub. No.: US 2011/0088088 A1
(43) Pub. Date: Apr. 14, 2011

(54) Method of frame blocking for wireless device

(76) Inventor: Guo Yuan Wang, Taipei City (TW)

(21) Appl. No.: 12/657,118

(22) Filed: Jan. 14, 2010

(30) Foreign Application Priority Data
Oct. 8, 2009 (TW) 098134061

(51) Int. Cl. G06F 21/20

(52) U.S. Cl. 726/12

(57) ABSTRACT

A frame blocking method for wireless device comprises the steps of: receiving a frame; determining if a size of the frame complies with a predetermined size? If “YES” then proceed; determining if the frame complies with a predetermined frame format? If “YES” then proceed; determining if an IP address contained in the frame is the same with a currently using IP address pre-stored in the client device? If “NO” then ignore the frame, if “YES” then handle the frame by normal operations. Therefore, unnecessary frames can be blocked as early as possible so as to save power and improve overall communicating quality.

### BACKGROUND OF INVENTION

1. Field of the Invention

The present invention relates to a method of frame blocking for a wireless device, and more particularly, to a method of frame blocking for a wireless device that is used in a wireless network environment to filter and block unnecessary frames at an early time.

2. Description of the Prior Art

Owing to the development thereof, wireless networks have now been ranked as a portion of the infrastructure of many public places. The wireless networks not only provide users with a convenient way of network connection, but also allow for extension of many services to a broader extent. For example, voice communication is just one of the key services.

As the users no longer need to connect the networks at a fixed place, the connection devices used are also made to be miniaturized for portability. Such wireless communication devices are called as mobile devices. Apart from having a small volume, the mobile devices also belong to one kind of embedded systems which are mostly designed for particular functional demands, so they are not provided with a too powerful computational capacity. This is intended to reduce unnecessary power consumption to extend the service time. Accordingly, how to extend the service time of mobile devices effectively has become a hot topic of research.

### SUMMARY OF INVENTION

The primary objective of the present invention is to provide a method of frame blocking for a wireless device. This method can filter and block unnecessary frames at an early time in order to reduce power consumption and improve overall communication quality.

In order to achieve the above objective, the present invention discloses a method of frame blocking for a wireless device. The wireless device has a predetermined IP address and a predetermined MAC address pre-recorded therein. The method of frame blocking comprises the following steps executed by the wireless device:

(A) receiving a frame from the outside;

(B) determining whether a size of the frame is consistent with a predetermined size, and if “yes”, then executing step (C), and otherwise, executing step (F);

(C) determining whether a header included in the frame complies with a predetermined format, and if “yes”, then executing step (D), and otherwise, executing step the (F);

(D) determining whether an IP address included in the frame is identical to the predetermined IP address, and if “yes”, then executing step (E), and otherwise, executing the step (F);

(E) deleting the frame and returning to the step (A); and

(F) processing the received frame through a normal procedure and returning to the step (A).

In a preferred embodiment, the header described in the step (C) includes an MAC header and an ARP header, and the step (C) further comprises the following steps of:

(C1) determining whether a Type field included in the MAC header of the frame complies with a predetermined Type format, and if “yes”, then executing the next step, and otherwise, executing the step (F); and

(C2) determining whether an Opcode field included in the ARP header of the frame complies with a predetermined Opcode format? if “yes”, then executing the next step, and otherwise, executing the step (F).

In a preferred embodiment, the predetermined size is 60 bytes, and the predetermined Type format has a value of 0x0806, while the predetermined Opcode format has a value of 0x01.

In a preferred embodiment, the wireless device is a VoIP phone, a VoIP gateway, an access point, a wireless network IP sharing switch, a wireless network base station, a computer with wireless network connection functionality, a cell phone with wireless network connection functionality or a handheld wireless network device.

In a preferred embodiment, the predetermined IP address and the predetermined MAC address are an IP address and an MAC address of the wireless device itself.

In a preferred embodiment, the wireless device is an access point, a wireless network IP sharing switch or a wireless network base station, and the predetermined IP address and the predetermined MAC address are an IP address and an MAC address of another wireless device located within wireless communication coverage of the wireless device, the method further comprising the following step before the step (A):

(A0) when the wireless device finds that the another wireless device is joining in to use the wireless service thereof, recording the IP address and the MAC address of the another wireless device for use as the predetermined IP address and the predetermined MAC address.

In a preferred embodiment, the wireless device stores the predetermined IP address and the predetermined MAC address, in form of a look-up table (LUT), into a memory.

### BRIEF DESCRIPTION OF THE DRAWINGS

The invention as well as a preferred mode of use and advantages thereof will be best understood by referring to the following detailed description of an illustrative embodiment in conjunction with the accompanying drawings, wherein:

FIG. 1 is a schematic diagram of a typical network architecture adapted for the method of frame blocking for a wireless device according to the present invention;

FIG. 2 is a schematic diagram of a typical network module architecture;

FIG. 3 is a flowchart of an embodiment of a method of frame blocking for a wireless device according to the present invention;

FIG. 4 illustrates a field architecture of a standard ARP frame;

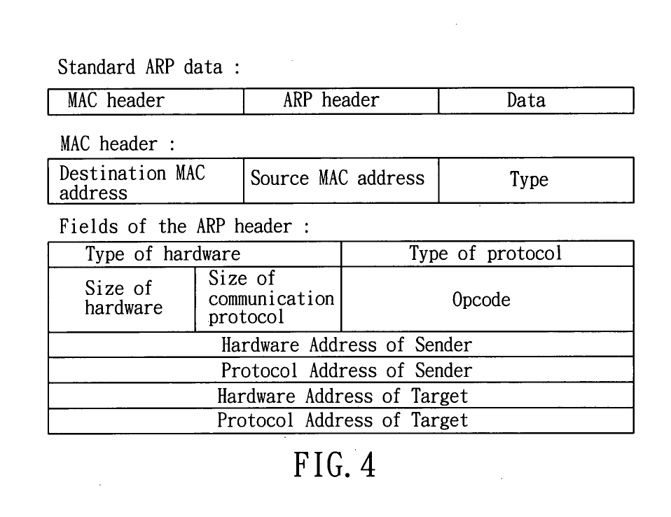

FIG. 5 illustrates an example of content of an MAC header and an ARP header in a typical ARP frame;

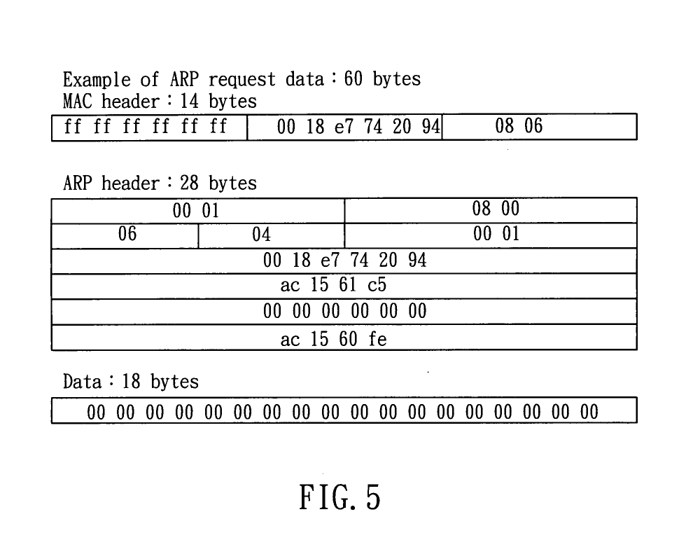

FIG. 6 is a schematic view of a network environment adopted in an experiment made on the method of frame blocking for a wireless device according to the present invention;

FIG. 7 illustrates results of a sound test in the experiment when the access point is set in a bridge mode; and

FIG. 8 illustrates results of a sound test in the experiment when the access point is set in a router mode.

### DETAILED DESCRIPTION OF PREFERRED EMBODIMENTS

Instead of describing theories by listing a number of complex algorithms whose feasibility is difficult to be proved, the method of frame blocking for a wireless device according to the present invention proposes an effective method and demonstrates, through actual experiments directly, the reduced power consumption and improved communication quality achieved by the method. Rather than being merely limited to application in voice communication devices, this method may be effectively applied to all mobile devices. Further, if the method proposed is practiced in a device responsible for bridging a wired network and a wireless network (e.g., an access point), then reduced power consumption and improved overall communication quality will be obtained for both the device itself and apparatuses within wireless signal coverage thereof.

To effectively reduce the power consumption, the present invention proposes a method of filtering unnecessary packets at the bottom layer of the system, which speeds up filtering of frames by determining features of the frames to discard unnecessary packets at an early time. This can shorten the wakeup time of the wireless device effectively so that the wireless device enters a sleep mode as early as possible to reduce the power consumption; meanwhile because the unnecessary packets are filtered at an early time, burden of the device in processing junk information is eased, thereby improving the overall communication quality.

To explain the method of frame blocking for a wireless device according to the present invention more clearly, embodiments thereof will now be described in detail.

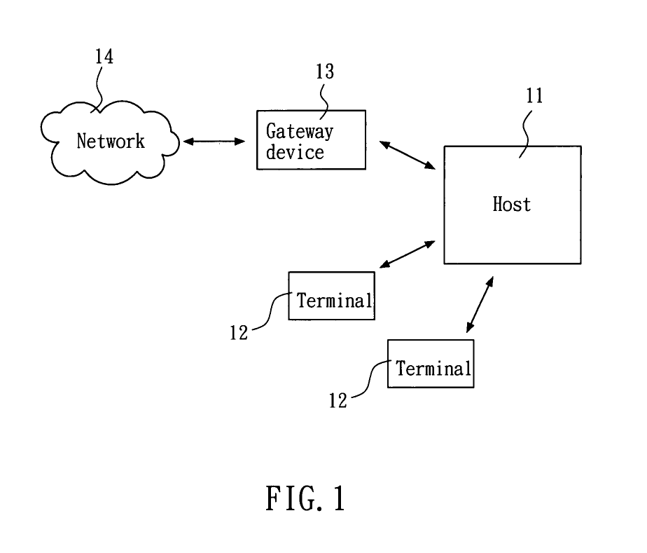

As shown in FIG. 1, a schematic diagram of a network architecture adapted for the method of frame blocking for a wireless device according to the present invention is shown therein. The method of frame blocking for a wireless device according to the present invention is implemented in a network environment, which comprises at least a host 11, a plurality of wireless devices 12 and at least a gateway device 13. The host 11 is connected via the gateway device 13 to an external network 14, for example but not limited to, the Internet, a telephone communication network or the like. The wireless devices 12 communicate with the host 12 through a wired or wireless network connection and receive services provided by the host 11. For example, taking a VoIP communication environment as an example, the host 11 may be a base unit; each of the wireless devices 12 may be a VoIP phone, a VoIP gateway, a computer with the VoIP phone functionality, a handheld network device or the like; the gateway device 13 may be a VoIP gateway; and the network 14 connected may be a telephone communication network. Taking a home IP sharing communication environment as another example, the host 11 may be a web server or a computer; each of the wireless devices 12 may be an access point, a wireless network IP sharing switch, a wireless network base station, a computer with wireless network connection functionality, a cell phone with wireless network connection functionality or a handheld wireless network device; the gateway device 13 may be an access point, a wireless network IP sharing switch or a wireless network base station; and the network 14 connected is the Internet.

The method of frame blocking for a wireless device according to the present invention may be implemented in the host 11, the wireless device 12 and the gateway device 13 shown in FIG. 1. When implemented in the wireless device 12, the present invention is able to reduce power consumption of the wireless device 12 itself and improve the communication quality thereof. On the other hand, when implemented in the gateway device 13, the present invention is able to provide reduced power consumption and overall communication quality improvement of both the gateway device 13 itself and all wireless devices 12 within wireless signal coverage thereof.

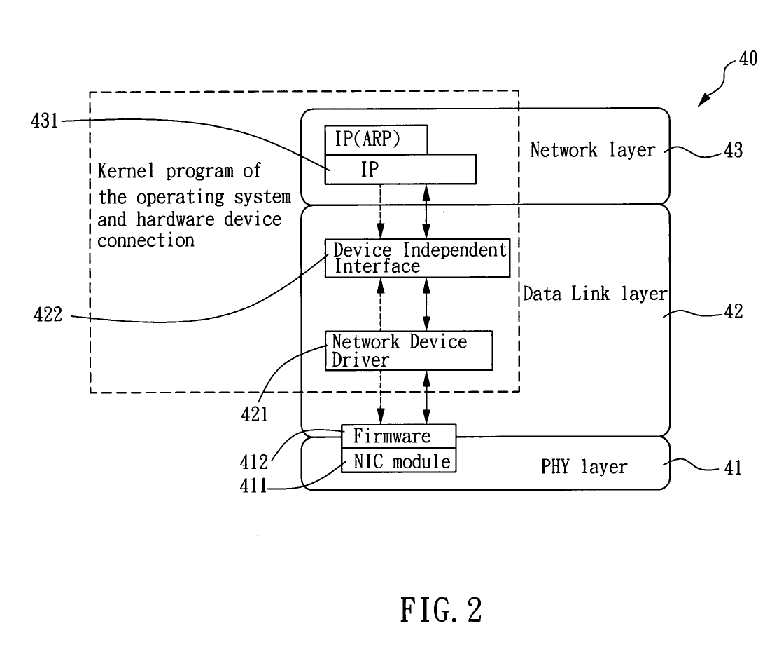

FIG. 2 is a schematic diagram of a typical network module architecture. Network modules of common devices with network communication functionality, including hosts and terminals, generally have an architecture similar to that of the network module 40, in other words, being composed of the PHY layer 41 at the bottom, the Data Link layer 42 above the PHY layer 41, and the Network layer 43 at the top. The PHY layer 41 includes therein a Network Interface Card (NIC) module 411 and a firmware 412. The Data Link layer 42 includes therein a Network Device Driver 421 and a Device Independent Interface 422. The Network layer 43 includes therein a network protocol 431, for example but not limited to, IP, ARP (Address Resolution Protocol) or the like. The network device driver 421, the device independent interface 422 and the network protocol 431 in combination substantially form a kernel program of the operating system and hardware device connection of the network module 40, for example but not limited to, Kernel® and the like.

The method of frame blocking for a wireless device according to the present invention may be implemented in the firmware 412 or the network device driver 421 of the network module 40. Taking the architecture shown in FIG. 2 as an example, the method implemented at a lower layer (e.g., in the firmware) provides better benefits. As to how the firmware 412 and the driver 421 can learn a specific condition to be detected, an application such as ioct1 may be used to inform the bottom layer of the condition to be detected after initiation of the method of smart detection and recovery according to the present invention, thereby launching the detecting operation.

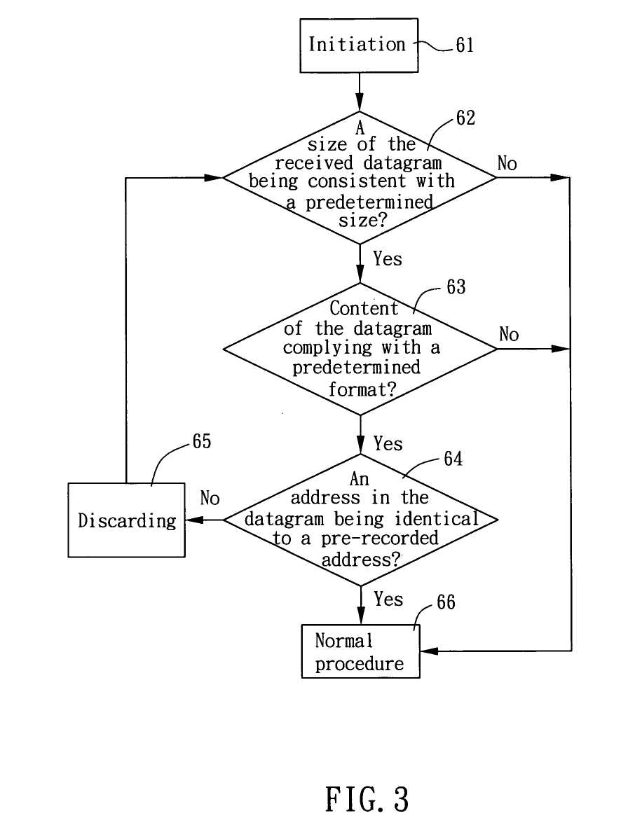

Referring to FIG. 3, there is shown a flowchart of an embodiment of the method of frame blocking for a wireless device according to the present invention. This method is implemented in the wireless device, the host or the gateway device shown in FIG. 1 to filter unnecessary frames as early as possible, a filtering process of which is as follow.

Step (61): Initiation

Firstly, the wireless device needs to pre-record a predetermined IP address and a predetermined MAC address and store them, in form of a look-up table (LUT), into a memory. Also stored in the memory of the wireless device is frame format information of the network communication protocol.

In an embodiment where the method of frame blocking according to the present invention is implemented in a wireless device (e.g., a mobile device, a wireless network phone, or the like), the predetermined IP address and the predetermined MAC address are an IP address and an MAC address of the wireless device itself.

In another embodiment where the method of frame blocking according to the present invention is implemented in a gateway device (e.g., an access point, a wireless network IP sharing switch, a wireless network base station, or the like), the predetermined IP address and the predetermined MAC address are an IP address and an MAC address of another wireless device located within wireless communication coverage (i.e., a range within which the services provided by the gateway device can be received) of the gateway device. If a plurality of wireless devices is located within the service coverage of the gateway, the IP addresses and the MAC addresses used by these wireless devices will all be recorded and stored into the memory in form of a LUT. Additionally, when the gateway device finds that the another wireless device is joining in to receive the wireless services thereof, the gateway device records the IP address and the MAC address of the another wireless device and adds them into the LUT as the predetermined IP address and the predetermined MAC address.

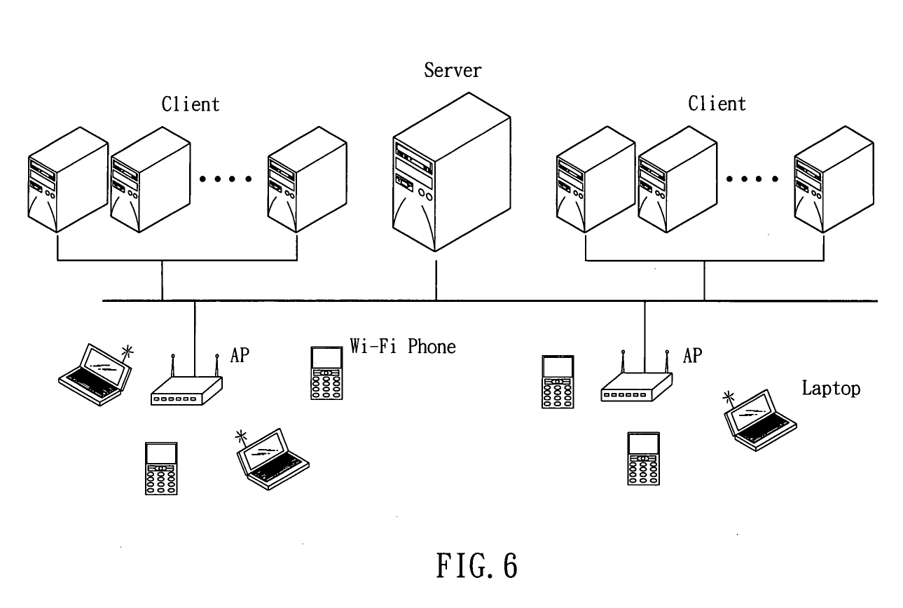

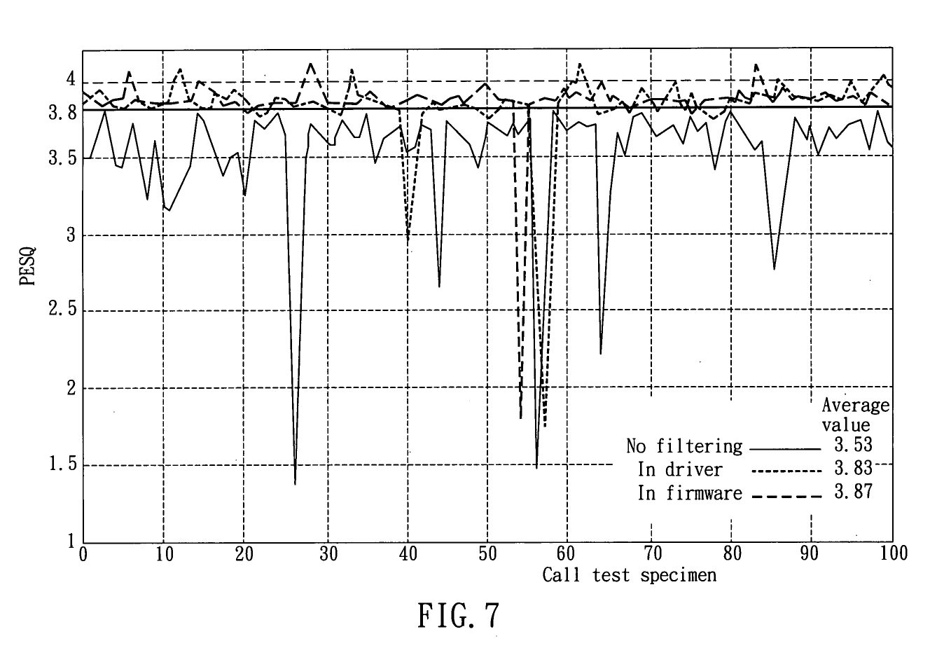

Referring to FIGS. 6 and 7, an example of a field architecture of a standard Address Resolution Protocol (ARP) frame and an example of content in the MAC header and the ARP header of a typical ARP frame are shown therein respectively. In this embodiment, the frame format information includes at least one of the following: a size of the frame, an MAC header and an ARP header. The MAC header at least further includes a Type field, and the ARP header at least further includes an Opcode field.

Then, the detecting process of the method of frame blocking for a wireless device according to the present invention is initiated to begin to receive a frame from the outside.

In Step (62), whether the size of the frame received is consistent with a predetermined size is to be determined. If yes, then step (63) is executed; otherwise, step (66) is executed.

Taking the standard ARP frame shown in FIGS. 6 and 7 as an example, the predetermined size of the frame is 60 bytes. Accordingly, if the size of the frame received by the wireless device is not 60 bytes, it means that the frame does not comply with ARP and, of course, is not of a packet form that shall be filtered, so step (66) may be executed directly to process the frame through a normal procedure.

Because this step only involves determining the size of the frame, it is the most straightforward, easiest and quickest way of filtering. Besides, because most packets commonly used in wireless communication protocols currently are frames complying with the ARP format, they are adapted for processing by the filtering method of the present invention. Therefore, the filtering method of the present invention may greatly ease the burden of the wireless terminal in processing the frame received, thereby resulting in reduced power consumption, a higher response speed and improved communication quality.

In Step (63), whether content of the frame complies with a predetermined format is to be determined. If yes, then step (64) is executed; otherwise, step (66) is executed.

Taking the standard ARP frame as an example, as shown in FIGS. 6 and 7, the content thereof includes the MAC header and the ARP header. The Type field in the MAC header has a format of 0x0806, and the Opcode field in the ARP header has a predetermined opcode format of 0x01. Hence, if content (e.g., the Type field described above) of the MAC header or the Opcode field of the ARP header included in the frame received by the wireless terminal does not comply with the predetermined format, it means that the frame does not comply with the ARP and, of course, is not of a packet form that shall be filtered, so step (66) may be executed directly to process the frame through a normal procedure. Because this step only involves comparing the frame with the predetermined format, it is the most straightforward, easiest and quickest way of filtering. Accordingly, this may greatly ease the burden of the terminal in processing the frame received, thereby resulting in reduced power consumption, a higher response speed and improved communication quality.

In Step (64), whether an address in the frame is identical to a pre-recorded address is to be determining. If not, then step (65) is executed; otherwise, step (66) is executed.

If the determination results of the aforesaid steps (62) and (63) are both “yes”, then it means that the frame received is in the right frame format of the communication protocol used by the wireless device, and then it is further determined whether the frame is a frame to be received and processed by the wireless device. In the step (64), it is determined whether an IP address included in the frame is just the predetermined IP address pre-recorded in the memory. If the determination result is “no”, then it means that the frame is not a frame to be processed by the wireless device and then step (65) is executed; otherwise, if the determination result is “yes”, it means that the frame is a frame to be received and processed by the wireless device and then step (66) is executed where data in the frame is further interpreted and processed through a normal procedure.

Step (65) involved abandoning. The frame is deleted and then the process returns to the step (62). Once it is found that the frame is not to be processed by the wireless device, the frame is deleted and then the process returns to the step (62) to continue to receive and filter other frames.

In Step (66), the received frame is processed through the normal procedure, and then the method returns back to the step (62) to continue to receive and filter other frames. Here, the “normal procedure” refers to the normal communication procedure in which, under normal connection conditions, communication and data transmission are made between a wireless device and other wireless devices (or a gateway device, a host or the like) and the wireless device receives services provided by the host.

Hereinafter, two examples of the method of frame blocking for a wireless device according to the present invention will be described in detail with reference to the “mobile device” and the “access point” described above.

### Example A

### Mobile Device

One feature of the mobile device is that it is powered by a battery, and once electrical power of the battery runs out, the device will fail to operate any longer. To extend the battery life of the device, various methods have been proposed. As one of these methods, what proposed in the present invention is a method that does not depart from the existing architecture and can be put into practice directly.

Due to the nature of wireless networks, the mobile device must wake up periodically to listen for any frame to be received and processed. The wireless device restores a power-saving sleep mode only if there is no frame to be received and processed. Therefore, how to extend the duration in which the wireless device stays in the sleep mode while still ensuring normal communication becomes a primary concern in reducing power consumption.

ARP Request is a kind of packets arising frequently in networks, and as can be known from FIG. 2, how to process this kind of packets can only be determined after transmission through a lot of layers. However, in practice, most of the ARP Request packets that are processed are irrelevant to the device itself, so the additional wakeup time taken to process these irrelevant data represents unnecessary power consumption. Accordingly, if these irrelevant ARP Request packets can be recognized and filtered at an early time, the wireless device will be allowed to restore the sleep mode as early as possible to save power. The practice proposed will now be detailed as follows.

Upon acquiring an IP address used by itself, the mobile device informs the bottom layer of this information to initiate the mechanism of frame blocking of the present invention. The mobile device will consider the ARP Request as a designated frame to be filtered and make an analysis thereon. The following determinations will be made on each frame received:

(A1) determining whether the frame received has a size of 60 bytes; if yes, then proceeding with the process;

(A2) determining whether the Type field of the MAC header is 0x0806 and the Opcode field of the ARP header is 0x01; if yes, then proceeding with the process;

(A3) determining whether the protocol address of target included in the frame is identical to the IP address currently used by the device itself; if not, then proceeding with the process;

(A4) deleting the frame automatically; and

(A5) if the method does not proceed after any of the above determinations, then processing the frame through the normal processing procedure.

This practice allows for recovery to the original processing procedure of frame once inconsistency is found, thereby easing burden imposed on the system by the filtering process.

### Example B

### Access Point

An access point (also termed as a wireless network base station) serves as a bridge for a wireless device to communicate with a wired network, and all network data to be exchanged with the wireless network must be transferred through this channel. Hence, if the method of the present invention is applied to such a traffic hub, then not only burden of the access point itself in processing unnecessary packets may be eased, but also interference of such packets to mobile devices using the wireless communication services thereof may be eliminated, thereby achieving goals of reducing power consumption and improving overall communication quality together.

When finding that a mobile device is joining in to use the wireless services thereof, the access point records an MAC address of and an IF address used by the mobile device in the LUT, and reports this information to the bottom layer so that the frame blocking mechanism of the present invention is able to operate. After the frame blocking function is enabled, the access point will, at a wired network interface, consider the ARP Request as a designated frame to be filtered and make an analysis thereon. The following determinations will be made on each frame received:

(B1) determining whether the frame received has a size of 60 bytes; if yes, then proceeding with the process;

(B2) determining whether the Type field of the MAC header included in the frame is 0x0806 and the Opcode field of the ARP header is 0x01; if yes, then proceeding with the process;

(B3) determining whether the protocol address of target included in the frame exists in the LUT; if not, then proceeding with the process;

(B4) deleting the frame automatically; and

(B5) if the process does not proceed after any of the above determinations, then processing the frame through the normal processing procedure.

Through such processing, ARP Request packets irrelevant to all wireless devices within the service coverage are filtered early at the access point, which avoids occupation of transmission bandwidth of the wireless interface by these packets or power loss caused by processing these packets after they are transmitted to the mobile devices. Depending on addition or deletion of records made by the access point with respect to mobile devices receiving the services thereof, data in the LUT can be altered dynamically to effectively control use of the LUT, thereby avoiding an excessive burden.

Experiments & Analysis

The present invention employs a Wi-Fi phone P204 from Advantage Century Telecommunication (ACT) Corp. as a platform of experiment. This device adopts uClinux as an operating system, and the power consumption thereof is about 6.5 mA in the sleep mode and averages about 250 mA in the wakeup mode. In the following experiments, the method of frame blocking according to the present invention is used for filtering the ARP Request packets, and is implemented in the firmware and the driver of the wireless module in order to test for improvement obtained from the method disclosed by the present invention.

The network environment for the experiments is shown in FIG. 6, and all access points operate in a bridge mode.

Experiment 1: Standby Time Test

When operating in this network environment, P204 exhibits an average standby time as shown in the following table.

TABLE 1
Average standby time

| Where the filtering | Standby time |
|---|---|
| is performed? | (hours) |
| No filtering | 11.2 |
| In the driver | 35.33 |
| In the firmware | 37.67 |

Such significant difference arises from the following reasons. When the access point is set in the bridge mode, data transmitted in the wired network will also arrive at the access point and be sent out by the wireless interface. Such data irrelevant to the wireless device is not filtered by devices such as a router but is received by the Wi-Fi phone, resulting in a prolonged wakeup time of the Wi-Fi phone.

Taking a time point when normal processing of an ARP Request packet is completed as a basis point for comparison, then when the method of frame blocking according to the present invention is applied to filter useless ARP Request packets early in the driver, 332˜8120 μs can be saved in processing each of the ARP Request packets. Moreover, if the useless ARP Request packets are filtered even earlier in the firmware of the wireless module, then 440˜8230 μs can be saved in processing each of the ARP Request packets. (Duration of the processing is also associated with a size of the routing table and the extent to which the system is busy.) Saving in time helps the system to return back to the sleep mode as early as possible for power-saving purpose. As a result, such significant difference in standby time occurs in the network environment where 241 ARP Request packets are received every minute on average.

Experiment 2: Sound Quality Test

The present invention employs test equipment Model J1981B from Agilent Technologies for the sound quality test. During the test, a P204 phone that filters ARP Request packets in the firmware of the wireless module was used fixedly at an originating end, another P204 phone was used at the receiving end, and PESQ (Perceptual Evaluation of Speech Quality) values were measured for three different manners of ARP Request packet processing. During the call, G.711 μ-Law was adopted for encoding/decoding of the sound, and one hundred times of call tests were made continuously for each of the three manners, with each call test having a sound duration of 11 seconds. The two P204 phones were located within communication coverage of a same access point during the test.

FIG. 7 shows measurement results when the access point was set in the bridge mode. As can be seen from these results, when the ARP Request packets were not filtered, the P204 phone under test had to receive and process these ARP Request packets from time to time. Consequently, too much system resource was wasted in processing these meaningless packets, resulting in that almost none of the measured PESQ values reached the standard value of 3.8 commonly recognized in the communication industry.

This is mainly due to the following reasons. As shown in FIG. 2, the ARP Request packets must be transmitted through several layers to the core of the system (i.e., the network layer) before it can be determined to be abandoned. This causes RTP missing of voice packets that shall otherwise be processed immediately due to a too long delay time, or causes loss of voice packets that would otherwise have been received due to busy conditions of the system.

In contrast, the method of frame blocking according to the present invention, no matter implemented in the firmware or the driver of the wireless module, can filter the ARP Request packet to effectively improve the PESQ value of voices, so it can keep a high quality of voice communication of the Wi-Fi phone even in a busy network. Although a few PESQ values not up to the standard can still be found in FIG. 7, this is due to that the network was so busy that some continuous voice packets sent by the originating end experienced several times of collision and retransmission before being received by the receiving end, causing a too long delay time and consequent RTP missing of these packets.

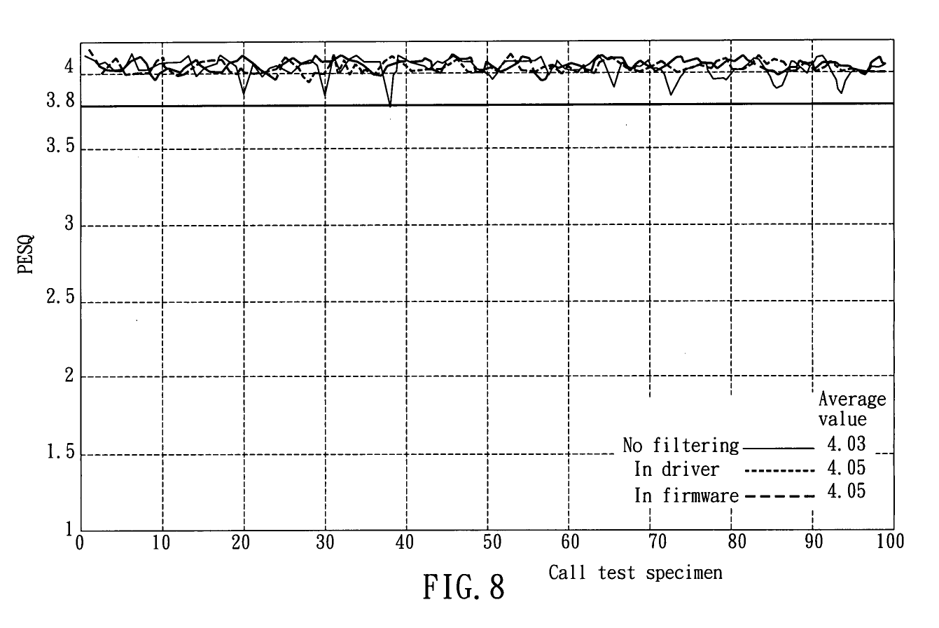

Next, the access point was set in a router mode, and an effect of the method proposed by the present invention under such conditions was observed, with the results being shown in FIG. 8. As can be found in FIG. 8, because under such conditions, the access point was responsible for filtering most of packets that ought not to be sent by the wireless interface, a better communication quality was obtained by the Wi-Fi phone when located in this environment. The method of frame blocking according to the present invention imposes no significant burden on the system, so the filtering operation has no influence on the communication quality.

It can be found from the previous experiments that, if the access point is set in the router mode, most of useless packets can be filtered by the access point to reduce power consumption and computational burden of the mobile device caused by these packets. Unfortunately, when operating in the router mode, most of access points usually also provide the DHCP service to provide virtual IP addresses for mobile devices wirelessly connected with the access points. However, this configuration hinders some services that can be provided only when a physical IP address is available.

A radius server may be provided for centralized control to allow mobile devices wirelessly connected with the access point to configure physical IP addresses via management of the radius server, so as to solve the problem of IP configuration. However, this is difficult to be achieved in many medium- or small-sized enterprises because this necessitates management by a specialized administrator in addition to cost of an additional server. Besides, not all access points and mobile devices can support authentication required by the radius server. Accordingly, the present invention discloses a general solution which is applicable no matter in what mode an access point operates or how an enterprise manages the right of accessing the network.

In summary, the present invention discloses an advanced method of frame blocking that filters frames useless to the wireless device early in the firmware or driver of the wireless module. This not only reduces the power consumption but also allows the system to have sufficient time to process data that is really in need of processing. When applied in voice communication, the present invention is able to improve the voice quality remarkably. Furthermore, this method is not restricted by the type of the network where the device is located, so it may be implemented in various mobile devices properly. When this method is applied to an access point, frame blocking may be accomplished in this traffic hub that bridges between a wireless network and a wired network so as to prevent devices using the wireless services thereof from being interfered by irrelevant packets, thereby saving more bandwidth for necessary communication, reducing power consumption of the device and improving the overall communication quality.

The present invention has been described with preferred embodiments thereof, and it is understood that many changes and modifications to the described embodiment can be carried out without departing from the scope and the spirit of the invention that is intended to be limited only by the appended claims.

What is claimed is:

1. A method of frame blocking for a wireless device, the wireless device having a predetermined IP address and a predetermined MAC address pre-recorded therein, the method comprising the following steps executed by the wireless device:
(A) receiving a frame from the outside;
(B) determining whether a size of the frame is consistent with a predetermined size, and if “yes”, then executing step (C), and otherwise, executing step (F);
(C) determining whether a header included in the frame complies with a predetermined format, and if “yes”, then executing step (D), and otherwise, executing step the (F);
(D) determining whether an IP address included in the frame is identical to the predetermined IP address, and if “yes”, then executing step (E), and otherwise, executing the step (F);
(E) deleting the frame and returning to the step (A); and
(F) processing the received frame through a normal procedure and returning to the step (A).

2. The method of claim 1, wherein the header described in the step (C) includes an MAC header and an ARP header, and the step (C) further comprises the following steps of:
(C1) determining whether a Type field included in the MAC header of the frame complies with a predetermined Type format, and if “yes”, then executing the next step, and otherwise, executing the step (F); and
(C2) determining whether an Opcode field included in the ARP header of the frame complies with a predetermined Opcode format? if “yes”, then executing the next step, and otherwise, executing the step (F).

3. The method of claim 2, wherein the predetermined size is 60 bytes, and the predetermined Type format has a value of 0x0806, while the predetermined Opcode format has a value of 0x01.

4. The method of claim 1, wherein the wireless device is a VoIP phone, a VoIP gateway, an access point, a wireless network IP sharing switch, a wireless network base station, a computer with wireless network connection functionality, a cell phone with wireless network connection functionality or a handheld wireless network device.

5. The method of claim 1, wherein the predetermined IP address and the predetermined MAC address are an IP address and an MAC address of the wireless device itself.

6. The method of claim 1, wherein the wireless device is an access point, a wireless network IP sharing switch or a wireless network base station, and the predetermined IP address and the predetermined MAC address are an IP address and an MAC address of another wireless device located within wireless communication coverage of the wireless device, the method further comprising the following step before the step (A):
(A0) when the wireless device finds that the another wireless device is joining in to use the wireless service thereof, recording the IP address and the MAC address of the another wireless device for use as the predetermined IP address and the predetermined MAC address.

7. The method of claim 1, wherein the wireless device stores the predetermined IP address and the predetermined MAC address, in form of a look-up table (LUT), into a memory.

8. A method of frame blocking for a wireless device, the wireless device having a predetermined IP address and a predetermined MAC address pre-recorded therein, and the method comprising the following steps executed by the wireless device:
(a) receiving a frame, which at least contains therein the following information: frame format information, MAC address information and IP address information;
(b) determining whether the frame format information complies with a predetermined frame format, and if “yes”, then executing step (c), and otherwise, executing step (e);
(c) determining whether the IP address included in the frame complies with the IP address currently used, and if “yes”, then executing step (d), and otherwise, executing the step (e);
(d) deleting the frame and returning to the step (a); and
(e) processing the received frame through a normal procedure and returning to the step (a).

9. The method of claim 8, wherein the frame format information at least includes a size of the frame, an MAC header and an ARP header, and the step (b) further comprises the following steps of:
(b1) determining whether the size of the frame is consistent with a predetermined size, and if “yes”, executing then step (b2), and otherwise, executing the step (e); and
(b2) determining whether a Type field included in the MAC header of the frame complies with a predetermined Type format, and if “yes”, then executing step (b3), and otherwise, executing the step (e); and
(b3) determining whether an Opcode field included in the ARP header of the frame complies with a predetermined Opcode format, and if “yes”, then executing the step (c), and otherwise, executing the step (e).

10. The method of claim 9, wherein the predetermined size is 60 bytes, and the predetermined Type format has a value of 0x0806, while the predetermined Opcode format has a value of 0x01.

11. The method of claim 8, wherein the wireless device is a VoIP phone, a VoIP gateway, an access point, a wireless network IP sharing switch, a wireless network base station, a computer with wireless network connection functionality, a cell phone with wireless network connection functionality or a handheld wireless network device.

12. The method of claim 8, wherein the predetermined IP address and the predetermined MAC address are an IP address and an MAC address of the wireless device itself.

13. The method of claim 8, wherein the wireless device is an access point, a wireless network IP sharing switch or a wireless network base station, and the predetermined IP address and the predetermined MAC address are an IP address and an MAC address of another wireless device located within wireless communication coverage of the wireless device, the method further comprising the following step before the step (a):
(a0) when the wireless device finds that the another wireless device is joining in to use the wireless service thereof, recording the IP address and the MAC address of the another wireless device for use as the predetermined IP address and the predetermined MAC address.

14. The method of claim 8, wherein the wireless device stores the predetermined IP address and the predetermined MAC address, in form of a look-up table (LUT), into a memory.
